(19) United States
(12) Patent Application Publication
(10) Pub. No.: US 2022/0395826 A1
(43) Pub. Date: Dec. 15, 2022

(54) MICROFLUIDIC SUBSTRATE, MICROFLUIDIC DEVICE AND DRIVING METHOD THEREOF

(71) Applicants: Beijing BOE Sensor Technology Co., Ltd., Beijing (CN); BOE TECHNOLOGY GROUP CO., LTD., Beijing (CN)

(72) Inventors: Bolin FAN, Beijing (CN); Yongjia GAO, Beijing (CN); Yingying ZHAO, Beijing (CN); Le GU, Beijing (CN); Wenliang YAO, Beijing (CN); Qiuxu WEI, Beijing (CN)

(21) Appl. No.: 17/606,716

(22) PCT Filed: Dec. 25, 2020
(86) PCT No.: PCT/CN2020/139526

§ 371 Date: Oct. 26, 2021

(51) Int. Cl. B01L 3/00

(52) U.S. Cl. CPC B01L 3/50273; B01L 2200/16; B01L 2300/0645; B01L 2400/0415

(57) ABSTRACT

The present disclosure relates to a microfluidic substrate, a microfluidic device and a driving method thereof. The microfluidic substrate includes a first area, the first area includes a first module for generating droplets, the first module includes a first electrode pair and a second electrode pair, and the first electrode pair and the second electrode pair are arranged in a crisscross pattern. The first electrode pair includes a first electrode and a second electrode, and the second electrode pair includes a third electrode and a fourth electrode.

### RELATED APPLICATIONS

The present application is a 35 U.S.C. 371 national stage application of PCT International Application No. PCT/CN2020/139526, filed on Dec. 25, 2020, the entire disclosure of which is incorporated herein by reference.

### TECHNICAL FIELD

The present disclosure relates to the field of biological detection, in particular to a microfluidic substrate, a microfluidic device and a driving method thereof.

### BACKGROUND

Microfluidics is a technology for precise control and manipulation of micro-scale fluids. In this technology, the basic operation units such as sample preparation, reaction, separation, and detection involved in the detection and analysis process can be integrated into a centimeter-level chip. Microfluidic technology is generally applied to the analysis process of trace drugs in the fields of biology, chemistry, medicine, etc. Microfluidic devices have advantages such as low sample consumption, fast detection speed, simple operation, multi-functional integration, small size and portability, and have huge application potential in the fields of biology, chemistry, medicine, etc.

### SUMMARY

According to an aspect of the present disclosure, there is provided a first substrate for a microfluidic device. The first substrate comprises a first area comprising at least one first module for generating droplets, the first module comprising a first electrode pair and a second electrode pair, wherein the first electrode pair and the second electrode pair are arranged in a crisscross pattern, the first electrode pair comprises a first electrode and a second electrode, and the second electrode pair comprises a third electrode and a fourth electrode.

In some embodiments, a width of the first electrode gradually decreases in a first direction, and a width of the second electrode gradually increases in the first direction.

In some embodiments, a width of the third electrode gradually decreases in a second direction, a width of the fourth electrode gradually increases in the second direction, and the second direction is perpendicular to the first direction.

In some embodiments, outer edges of the first electrode, the second electrode, the third electrode, and the fourth electrode form a quadrilateral.

In some embodiments, the outer edges of the first electrode, the second electrode, the third electrode, and the fourth electrode form a square.

In some embodiments, the facing outer edges of the first electrode and the second electrode have a radius of curvature greater than a quarter of a side length of the square.

In some embodiments, the shapes of the first electrode and the second electrode are semicircles.

In some embodiments, the facing outer edges of the first electrode and the second electrode have a radius of curvature less than a quarter of the side length of the square.

In some embodiments, the shapes of the first electrode and the second electrode are isosceles triangles.

In some embodiments, the pattern composed of the first electrode, the second electrode, the third electrode, and the fourth electrode is a centrally symmetric pattern.

In some embodiments, the shapes of the third electrode and the fourth electrode match the shapes of the first electrode and the second electrode.

In some embodiments, the first module further comprises a fifth electrode, a sixth electrode, a seventh electrode arranged in sequence along the second direction upstream of the first electrode, the second electrode, the third electrode, and the fourth electrode, and an eighth electrode downstream of the first electrode, the second electrode, the third electrode, and the fourth electrode, and wherein the sixth electrode comprises a recess, and at least a part of the seventh electrode is in the recess of the sixth electrode.

In some embodiments, at least half of a width of the seventh electrode in the second direction is in the recess of the sixth electrode.

In some embodiments, the fifth electrode and the sixth electrode are arranged in an interdigital electrode arrangement.

In some embodiments, gaps exist between every two adjacent electrodes of the first to eighth electrodes, and the gaps have a constant width.

In some embodiments, the first area is selected from at least one of a sample and reagent storage area and a detergent storage area.

In some embodiments, the first substrate further comprises a second area and a third area, the third area comprises a second module, a third module, and a fourth module, and the second module is connected to the second area through a first electrode path, the third module and the fourth module are connected to the second area through a second electrode path.

In some embodiments, the second area comprises a purification area, the third area comprises a sample output area, the second module comprises a waste liquid module, the third module comprises a quality control module, and the fourth module comprises a product module.

In some embodiments, the first substrate comprises: a first base substrate; a metal wiring layer on the first base substrate; an insulating layer on a side of the metal wiring layer away from the first base substrate; an electrode layer on a side of the insulating layer away from the first base substrate; a dielectric layer on a side of the electrode layer away from the first base substrate; and a hydrophobic layer on a side of the dielectric layer away from the first base substrate.

In some embodiments, the first module, the second module, the third module, and the fourth module are in the electrode layer, and each electrode of the first module, the second module, the third module and the fourth module is connected to the metal wiring layer through a via penetrating the insulating layer.

In some embodiments, the electrode layer is an ITO layer.

According to another aspect of the present disclosure, there is provided a microfluidic device. The microfluidic device comprises the first substrate according to the previous aspect, a second substrate assembled with the first substrate, and a slit between the first substrate and the second substrate, wherein the second substrate comprises: a second base substrate; a conductive layer on the second base substrate; and a hydrophobic layer on a side of the conductive layer away from the second base substrate.

According to another aspect of the present disclosure, there is provided a driving method of a microfluidic device. The method comprises: energizing the fifth electrode, the sixth electrode, and the seventh electrode; energizing the first electrode, the second electrode, the third electrode, and the fourth electrode, while de-energizing the fifth electrode, the sixth electrode, and the seventh electrode; energizing the eighth electrode; de-energizing the first electrode and the second electrode, while energizing the fifth electrode, the sixth electrode, and the seventh electrode; de-energizing the third electrode and the fourth electrode; and de-energizing the seventh electrode.

### BRIEF DESCRIPTION OF THE DRAWINGS

In order to more clearly illustrate the technical solutions in embodiments of the disclosure, the drawings needed to be used in the description of the embodiments will be introduced briefly in the following. Obviously, the drawings in the following description are only some embodiments of the disclosure, and for those of ordinary skills in the art, other drawings may be obtained according to these drawings under the premise of not paying out creative work.

FIG. 1A schematically shows a top view of a first module according to an embodiment of the present disclosure;

FIG. 1B schematically shows a top view of a first module according to another embodiment of the present disclosure;

FIG. 1C schematically shows a top view of a first module according to yet another embodiment of the present disclosure;

FIG. 2A schematically shows a top view of a first module according to still another embodiment of the present disclosure;

FIG. 2B schematically shows a top view of a first module according to still another embodiment of the present disclosure;

FIG. 3 schematically shows a cross-sectional view of the microfluidic device taken along the line A-B in FIG. 2B;

FIG. 4 schematically shows a top view of a first substrate according to an embodiment of the present disclosure;

FIG. 5A schematically shows a top view of a second substrate according to an embodiment of the present disclosure;

FIG. 5B schematically shows a top view of a microfluidic device according to an embodiment of the present disclosure;

FIG. 6 shows a process diagram of using the first module shown in FIG. 2B to generate droplets;

FIG. 7 schematically shows a droplet breaking neck diagram; and

FIG. 8 schematically shows a top view of a microfluidic device according to another embodiment of the present disclosure.

The shapes and sizes of the parts in the drawings do not reflect the true proportions of the parts, but merely schematically illustrate the present disclosure.

### DETAILED DESCRIPTION OF THE DISCLOSURE

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative work shall fall within the protection scope of the present disclosure.

The inventors found that in a microfluidic device, the accuracy of droplet generation is closely related to the surface energy of the liquid, and that reagents with different surface energies have different accuracies of droplet generation. For applications (such as library construction), involving multiple reagents or reagent systems it is difficult for conventional microfluidic devices to accurately control all reagents.

A microfluidic device that uses the principle of dielectric wetting usually includes two substrates assembled together. One of the substrates includes an electrode layer, and the electrode layer includes a plurality of surface electrodes for driving the liquid. The shape and arrangement of the plurality of surface electrodes can be designed according to actual needs, so as to realize the precise control of the liquid. It should be noted that the shape of the electrode mentioned in the present disclosure all refers to the shape of the electrode in the plane of the electrode layer.

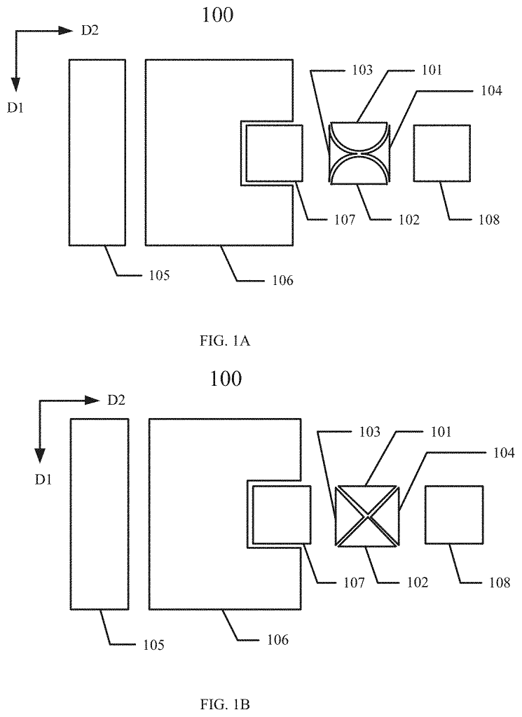

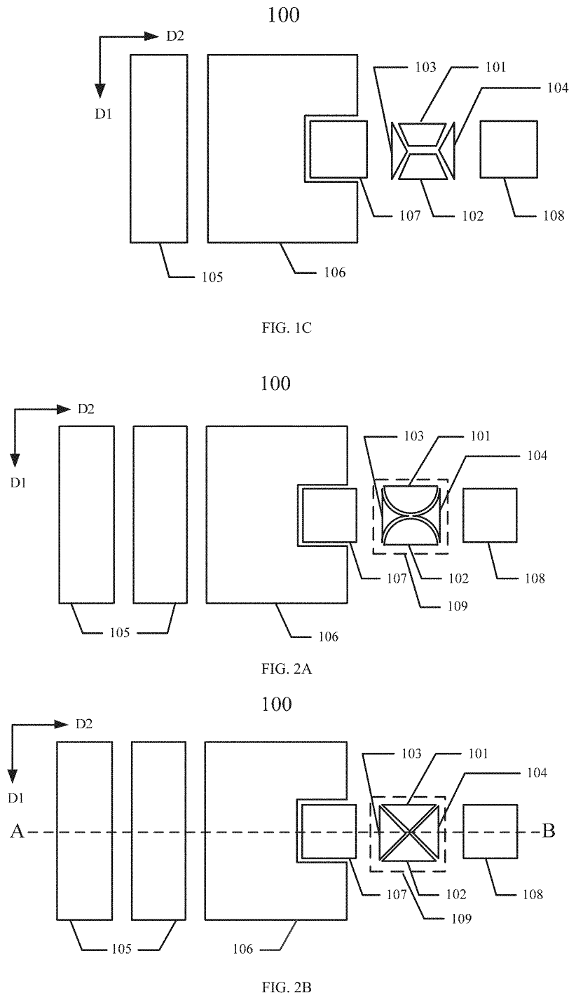

The present disclosure provides a first substrate for a microfluidic device, hereinafter referred to as the first substrate for short. The first substrate includes a first area, and the first area includes at least one first module for generating droplets. FIGS. 1A, 1B, and 1C schematically show top views of the first module 100 in the electrode layer of the first area of the first substrate. As shown in FIGS. 1A, 1B and 1C, the first module 100 includes a first electrode pair (101, 102) and a second electrode pair (103, 104), the first electrode pair and the second electrode pair are arranged in a crisscross pattern.

In some embodiments, as shown in FIGS. 1A, 1B, and 1C, the first electrode pair includes a first electrode 101 and a second electrode 102, and the second electrode pair includes a third electrode 103 and a fourth electrode 104.

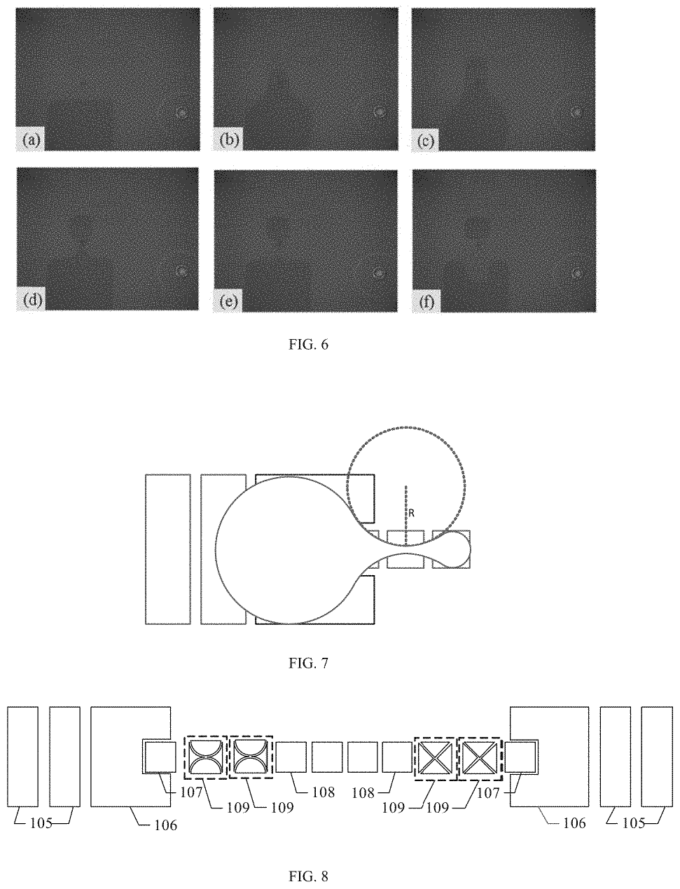

In the droplet generation process, the first electrode, the second electrode, the third electrode and the fourth electrode work together to assist the droplet to form a neck (as shown in FIG. 7) (the first electrode and the second electrode can be called the droplet generation auxiliary electrodes, and the third electrode and the fourth electrode can be called supplementary electrodes), to determine the narrowest position of the neck, which can reduce the randomness of droplet breaking and thus improve its breaking accuracy, thereby reducing the coefficient of variation of droplet generation.

In some embodiments, as shown in FIGS. 1A, 1B, and 1C, the width of the first electrode 101 gradually decreases along the first direction D1, and the width of the second electrode 102 gradually increases along the first direction D1. Such a first electrode and a second electrode can assist in determining the narrowest position of the neck, reduce the randomness of droplet breaking, and improve its breaking accuracy.

In some embodiments, as shown in FIGS. 1A, 1B, and 1C, the width of the third electrode 103 gradually decreases along the second direction D2, and the width of the fourth electrode 104 gradually increases along the second direction D2, with the second direction D2 perpendicular to the first direction D1. The first electrode, the second electrode, the third electrode and the fourth electrode work together to make the narrowest position of the neck of the droplet more certain and further improve the breaking accuracy.

It should be understood that the “width” of the first electrode 101 refers to the size of the first electrode 101 in the second direction D2, and the “width” of the second electrode 102 refers to the size of the second electrode 102 in the second direction D2. The “width” of the third electrode 103 refers to the size of the third electrode 103 in the first direction D1, and the “width” of the fourth electrode 104 refers to the size of the fourth electrode 104 in the first direction D1. As shown in FIGS. 1A, 1B, and 1C, the second direction D2 and the first direction D1 are perpendicular to each other, and the liquid driven by the microfluidic device in operation flows along the second direction D2.

In some embodiments, the outer edges of the first electrode 101, the second electrode 102, the third electrode 103, and the fourth electrode 104 may form a quadrilateral, such as a square, a rectangle, a parallelogram, a trapezoid, and the like. As shown in FIGS. 1A, 1B, and 1C, the outer edges of the first electrode 101, the second electrode 102, the third electrode 103, and the fourth electrode 104 may form a square. In view of the different properties of the driven liquid, in some embodiments, the facing outer edges of the first electrode and the second electrode may have a radius of curvature greater than a quarter of the side length of the square. As shown in FIG. 1A, the first electrode 101 and the second electrode 102 can each have a shape of a semicircle (the radius of curvature of the outer edges facing each other is one-half of the side length of the square). This design is advantageous for generation of droplets of high surface energy reagents. In some embodiments, the facing outer edges of the first electrode and the second electrode have a radius of curvature less than a quarter of the side length of the square. As shown in FIG. 1B, the first electrode 101 and the second electrode 102 can each have a shape of an isosceles triangle (the radius of curvature of the outer edges facing each other is much smaller than a quarter of the side length of the square). This design is advantageous for generation of droplets of low surface energy reagents.

In some embodiments, as shown in FIG. 1C, the first electrode 101 and the second electrode 102 may each have a shape of an isosceles trapezoid. In this case, the third electrode 103 and the fourth electrode 104 may each have a shape of an isosceles triangle which matches the two opposing isosceles trapezoids, as shown in FIG. 1C.

In some embodiments, as shown in FIGS. 1A, 1B, and 1C, the pattern composed of the first electrode 101, the second electrode 102, the third electrode 103, and the fourth electrode 104 may be a center-symmetric pattern. This makes the distribution of the driving electric field more uniform and stable, and improves the stability of droplet generation.

In some embodiments, as shown in FIG. 1A and FIG. 1B, the shapes of the third electrode 103 and the fourth electrode 104 match the shapes of the first electrode 101 and the second electrode 102. The matching of the shapes of the four electrodes can make the narrowest position of the droplet neck more certain, and can make the driving electric field distribution stable, which can simultaneously improve the accuracy and stability of droplet generation.

It should be understood that the shapes of the third electrode 103 and the fourth electrode 104 “match” the shapes of the first electrode 101 and the second electrode 102 means that the second electrode pair composed of the third electrode 103 and the fourth electrode 104 and the first electrode pair composed of the first electrode 101 and the second electrode 102 have substantially complementary shapes. In some embodiments, as shown in FIGS. 1A and 1B, the shapes of the first electrode 101, the second electrode 102, the third electrode 103, and the fourth electrode 104 match, and there is a gap of constant size between the respective electrodes.

In some embodiments, as shown in FIGS. 1A, 1B, and 1C, the first module 100 may further include a fifth electrode 105, a sixth electrode 106, and a seventh electrode 107 arranged in sequence along the second direction D2 upstream of the first electrode 101, the second electrode 102, the third electrode 103, and the fourth electrode 104, and an eighth electrodes 108 downstream of the first electrode 101, the second electrode 102, the third electrode 103, and the fourth electrode 104. The sixth electrode 106 includes a recess, and at least a part of the seventh electrode 107 is located in the recess of the sixth electrode 106.

Herein, the “upstream” of the electrode refers to a position where the liquid driven by the microfluidic device in operation has flowed through before flowing through the electrode, and the “downstream” of the electrode refers to a position where the liquid driven by the microfluidic device in operation will flow through after flowing through the electrode.

In some embodiments, at least half of the width of the seventh electrode 107 in the second direction D2 is located in the recess of the sixth electrode 106.

Exemplarily, the size of the fifth electrode is 1 mm×3 mm, the size of the sixth electrode is 2 mm×3 mm, the sizes of the seventh electrode and the eighth electrode are 1 mm×1 mm respectively, the first electrode, the second electrode, the third electrode and the fourth electrode together form a square of 1 mm×1 mm. There is a gap between the respective electrodes, and in some embodiments, the gap may have a constant width, for example, 10 microns.

In some embodiments, the fifth electrode and the sixth electrode may be arranged in an interdigital electrode arrangement.

In some embodiments, as shown in FIGS. 2A and 2B, the fifth electrode 102 may include two electrodes side by side.

There are gaps between adjacent ones of the first to eighth electrodes, and these gaps may have a constant width, for example, 10 microns.

In fact, each electrode mentioned in the present disclosure may include one or more electrodes. The more the number of electrodes is, the finer the manipulation of the liquid is. Those skilled in the art can make specific designs according to actual needs in combination with processing accuracy, which is not limited herein. Meanwhile, multiple electrodes (e.g., the third electrode and the fourth electrode) mentioned in the present disclosure can also be combined to form one electrode, as long as the corresponding technical effect can be achieved. The shape of the electrode is not limited to the shape shown in the drawings of the foregoing embodiment, and the skilled person can design other suitable shapes according to actual needs.

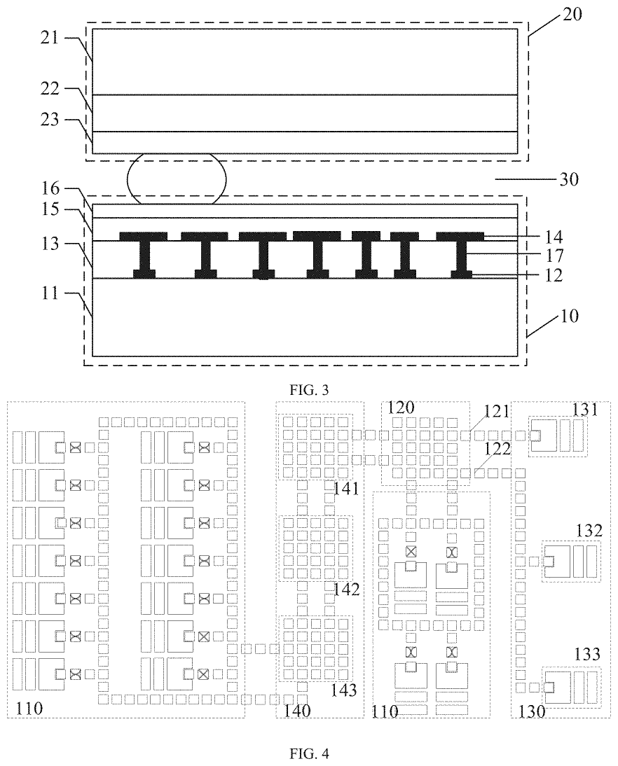

FIG. 3 schematically shows a cross-sectional view of the microfluidic device taken along the line A-B in FIG. 2B. As shown in FIG. 3, the first substrate 10 includes: a first base substrate 11, a metal wiring layer 12 on the first base substrate 11, and an insulating layer 13 on a side of the metal wiring layer 12 away from the first base substrate 11, an electrode layer 14 on a side of the insulating layer 13 away from the first base substrate, a dielectric layer 15 on a side of the electrode layer 14 away from the first base substrate, and a hydrophobic layer 16 on a side of the dielectric layer 15 away from the first base substrate. The first to eighth electrodes are located in the electrode layer 14, and each electrode is connected to the metal wiring layer 14 through a via 17 penetrating the insulating layer 13, and each electrode can be individually controlled to be energized. In some embodiments, the first base substrate 11 may be a glass base substrate, the metal wiring layer 12 may be made of a metal with low sheet resistance such as Mo, the insulating layer 13 may be made of a material such as silicon nitride and silicon dioxide, the electrode layer 14 can be made of ITO material, the dielectric layer 15 can be made of a PI film with a dielectric constant of 3.2, and a thickness of the hydrophobic layer can be 100 nm.

The microfluidic device provided by the present disclosure further includes a second substrate that is assembled with the first substrate, and a slit 30 between the first substrate and the second substrate. As shown in FIG. 3, the second substrate 20 includes: a second base substrate 21, a conductive layer 22 on the second base substrate 21, and a hydrophobic layer 23 on a side of the conductive layer 22 away from the second base substrate 21. The second base substrate may be a glass base substrate, and the conductive layer 22 may be made of ITO material. The liquid moves in the slit 30 between the first substrate and the second substrate driven by the electrodes.

Taking the first module shown in FIG. 2B as an example, the process of using the microfluidic device provided by the present disclosure to generate droplets is described in detail. FIG. 6 shows a process diagram of using the first module shown in FIG. 2B to generate droplets. In the process of droplet manipulation, a sine signal of 180 Vrms at 1 KHz is used, and the electrode is supplied with electricity at an interval of 500 ms. In the initial state, all electrodes are at 0 V. At first, the fifth electrode, the sixth electrode and the seventh electrode are energized, and the droplet deforms accordingly, as shown in FIG. 6(a). Then the first electrode, the second electrode, the third electrode and the fourth electrode are energized (that is, the voltage becomes 180 Vrms), while the fifth electrode, the sixth electrode, and the seventh electrode are de-energized (that is, the voltage becomes 0 V), and the droplet shape is shown in FIG. 6(b). Then the eighth electrode is energized, and the droplet shape is shown in FIG. 6(c). After that, the first electrode and the second electrode are de-energized, while the fifth electrode, the sixth electrode, and the seventh electrode are energized, and the droplet shape is shown in FIG. 6(d). Then the third electrode and the fourth electrode are de-energized, and the droplet shape is shown in FIG. 6(e). Finally, the seventh electrode is de-energized, the droplet shape is shown in FIG. 6(f), and the generation of the droplet is completed.

In the process of droplet generation, a liquid neck is formed (as shown in FIG. 7), and then the liquid breaks at the neck. Due to the randomness of the droplet breaking process, there is a variation for the breaking position of each droplet. As a result, the size of the generated droplets is different, which makes the coefficient of variation (CV) large. When the microfluidic device provided by the present disclosure is used, the first electrode, the second electrode, the third electrode, and the fourth electrode work together to assist the droplet to form a narrow neck, to determine the narrowest position of the neck, which can reduce the randomness of droplet breaking and thus improve its breaking accuracy, thereby reducing the coefficient of variation of droplet generation. As shown in FIGS. 2A and 2B, the first electrode, the second electrode, the third electrode, and the fourth electrode are combined to form a droplet neck control part 109. The first electrode and the second electrode may be called droplet generating auxiliary electrodes, and the third electrode and the fourth electrode may be called supplementary electrodes.

The smaller the radius of curvature of the first electrode and the second electrode is, the higher the breaking accuracy is. However, due to the surface tension of the liquid, the radius of curvature of the droplet neck cannot be decreased indefinitely. The pressure introduced by the surface tension can be described by the following formula:

p=γ/R

where γ is the surface tension coefficient of the liquid, and R is the radius of curvature at the neck whose direction points to the center of the circle. The first electrode, the second electrode, the third electrode, and the fourth electrode assist to form the neck by using the dielectric wetting effect to control the droplet shape. When R decreases, the pressure P increases, the required external force (the force generated by the dielectric wetting effect) to maintain the droplet shape needs to be increased accordingly. However, the driving force (i.e., the pressure that can be overcome) generated by the dielectric wetting effect is constant, so the radius of curvature of the droplet cannot be decreased indefinitely. For high surface energy reagents or reagent systems, the surface tension coefficient is relatively large. When the auxiliary electrode with a large radius of curvature is used, the generation accuracy can be significantly improved. Therefore, when the first module shown in FIG. 2A is used, the coefficient of variation of droplet generation can be significantly reduced. For low surface energy reagents or reagent systems, the surface tension coefficient is small, and when the auxiliary electrode with a small radius of curvature is used, its generation accuracy is high. Therefore, when the first module shown in FIG. 2B is used, a small radius of curvature is obtained, which reduces the randomness of its neck formation, and the coefficient of variation of droplet generation can be significantly reduced.

After testing, using the first module shown in FIG. 2A can effectively improve the droplet generation accuracy and stability of high surface energy reagents (such as deionized water, repair enzymes, magnetic beads, primers, etc.). Taking deionized water as an example, when the first module shown in FIG. 2A is used, the CV of droplet generation can be less than 0.5%. When the first module shown in FIG. 2B is used, the CV of droplet generation is between 0.5% and 1%. When the first module of the present disclosure is not used, the CV of droplet generation is greater than 1%. Using the first module shown in FIG. 2B can effectively improve the droplet generation accuracy and stability of low surface energy reagents (such as ethanol, transposase buffer, PCR mix, etc.). Taking the transposase storage buffer as an example, when the first module shown in FIG. 2B is used, the CV of droplet generation can be less than 0.3%, while when the first module shown in FIG. 2A is used, the CV of droplet generation is between 0.7% and 0.9%. When the first module of the present disclosure is not used, the CV of droplet generation is about 2%.

In some embodiments, as shown in FIG. 4, the first substrate may include a first area 110, a second area 120, a third area 130, and a fourth area 140. The third area 130 includes a second module 131, a third module 132 and a fourth module 133. The second module 131 is connected to the second area 120 through the first electrode path 121, and the third module 133 and the fourth module 134 are connected to the second area 120 through the second electrode path 122. The second module is connected to the second area through a different electrode path from the third module and the fourth module, which can avoid the mutual influence of the liquid of each module and improve the accuracy of the microfluidic device.

Taking the library construction based on microfluidics as an example, the first area may be a sample and reagent storage area or a detergent storage area. Exemplarily, the first area 110 on the left side of FIG. 4 is a sample and reagent storage area, including twelve first modules as shown in FIG. 2A and two first modules as shown in FIG. 2B which can store fourteen kinds of samples and reagents. The first area 110 in the middle of FIG. 4 is a detergent storage area, including three first modules as shown in FIG. 2A and one first module shown in FIG. 2B which can store four kinds of detergents. In the first area, the first module may be a generation module. The auxiliary electrode shape of the generation module can be designed according to the properties of different reagents. The second area may be a purification area, composed of 5×5 square electrodes of 1 mm×1 mm. The third area may be a sample output area, where the second module may be a waste liquid module, the third module may be a quality control module, and the fourth module may be a product module. The waste liquid module is connected to the purification area through the first electrode path, and the quality control module and the product module are connected to the purification area through the second electrode path. The first electrode path and the second electrode path may be formed by square electrodes of 1 mm×1 mm. The fourth area can be a temperature control area. The temperature control area can be composed of three regions (for example, the first temperature region 141, the second temperature region 142 and the third temperature region 143 shown in FIG. 4) which can control temperature separately. Each region is composed of 5×5 square electrodes of 1 mm×1 mm. The above-mentioned areas are connected by 1 mm×1 mm square electrodes, and the relative position and connection method of each area are shown in FIG. 4.

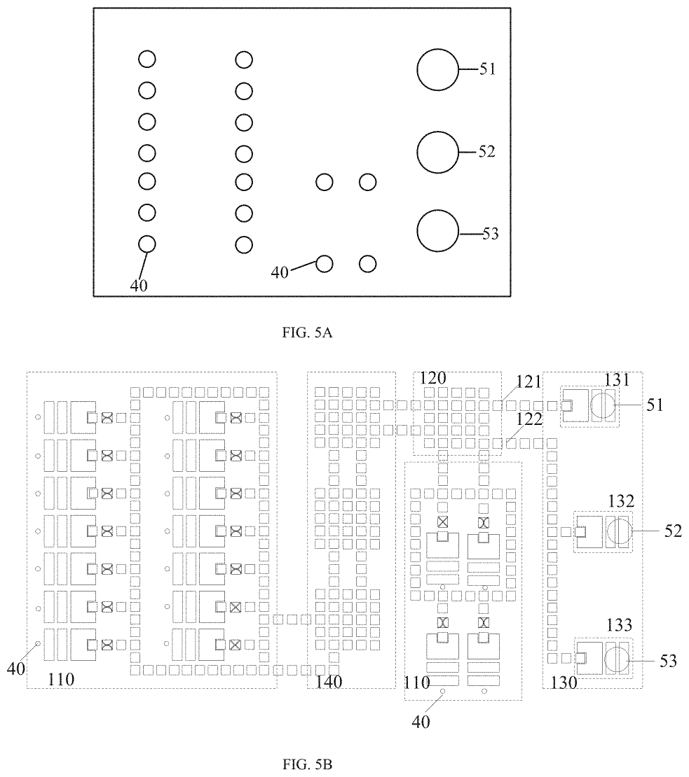

FIG. 5A schematically shows a top view of the second substrate of the microfluidic device, and FIG. 5B schematically shows a top view of the microfluidic device. As shown in FIG. 5A and FIG. 5B, at a certain distance (e.g., 0.5 mm) from the fifth electrode of each the above-mentioned first modules, there is a sample input hole 40 (e.g., a sample input hole with a diameter of 0.9 mm) on the second substrate. There are sample output holes (e.g., a sample output hole with a diameter of 2 mm) above the last two electrodes of the three modules in the sample output area. A first sample output hole 51 is above the second module, and a second sample output hole 52 is above the third module, and a third sample output hole 53 is above the fourth module.

The waste liquid sample output hole and the quality control and product sample output hole are connected to the purification area through different paths, which can effectively avoid sample contamination and thereby improve the accuracy of the microfluidic device.

The method of using the microfluidic device provided in the present disclosure is described below by taking the library construction process as an example:

(1) Place two low surface energy reagents, PCR mix and transposase storage buffer in the generation module as shown in FIG. 2B in the sample and reagent storage area, and place about ten other high surface energy reagents and samples in the generation module as shown in FIG. 2A. Place the ethanol in the generation module as shown in FIG. 2B in the detergent storage area, and place the magnetic beads and the other two detergents in the generation module as shown in FIG. 2A in the detergent storage area.

(2) Control the generation of 2 microliters of DNA samples, 8 microliters of transposase buffer and deionized water, mix them in the first temperature region of the temperature control area, and keep them at 55° C. for 5 min;

(3) After the heat preservation, add 1 microliter of protease buffer to the above reaction system, keep them at 55° C. for 5 min, and then control the reagent system to the third temperature region to be kept at 95° C. for 5 min;

(4) After the heat preservation, add 12 microliters of PCR mix and 2 microliters of primers to the above reaction system, then control the reagent system to the second temperature region and keep it at 72° C. for 5 min, then control the above reaction system to the third temperature region and keep it at 95° C. for 1 min. Then control the temperature of the third temperature region to 95° C., the temperature of the second temperature region to 65° C., and the temperature of the first temperature region to 72° C. Control the above reaction system to the third temperature region for 30 s, to the second temperature region for 30 s, to the first temperature region for 2 min, repeat this process 15 times, and finally control the reaction system to the third temperature region for 10 min.

(5) Control the temperature control area to return to normal temperature, drive the above reaction system to the purification area, and add 10 microliters of magnetic beads to the purification area for purification. Take out the waste liquid from the first sample output hole in the sample output area, and then add 20 microliters of ethanol for washing, and repeat the ethanol washing 4 times, and the waste liquid was also taken out from the first sample output hole. After that, add 15 microliters of deionized water for washing.

(6) Take 1 microliter of the above reaction system for quality control, and take it out from the second sample output hole.

(7) Control the above product to the first temperature region, add 6 microliters of repair enzyme, and keep it at room temperature for 5 min, and then heat up to 65° C. for 5 min.

(8) Control the above product to purification area, and carry out purification according to step (5).

(9) Take the above product and add 5 microliters of adapters, 10 microliters of ligase, and keep them at room temperature for 10 min, then wash 4 times with 20 microliters of washing buffer according to step (5), and then take 1 microliter of product for quality control, and finally take out all the products from the third sample output hole and complete the library construction.

In other embodiments, the first module may include a plurality of droplet neck control parts. FIG. 8 schematically shows a top view of a microfluidic device according to another embodiment of the present disclosure. As shown in FIG. 8, the first module 110 on the left includes two droplet neck control parts 109 as shown in FIG. 2A, and the first module 110 on the right includes two droplet neck control parts 109 as shown in FIG. 2B. This arrangement can obtain smaller droplets on the basis of small droplets, further improving the accuracy and stability of droplet generation. In addition, the two electrodes of the fifth electrode 105 may be arranged in an interdigital electrode arrangement, and the fifth electrode 105 and the sixth electrode 106 may be arranged in an interdigital electrode arrangement.

In the description of the present disclosure, the terms “above”, “below”, “left”, “right”, etc. indicate the orientation or positional relationship based on the orientation or positional relationship shown in the drawings, and are only used to facilitate the description of the present disclosure. It is not required that the present disclosure must be constructed and operated in a specific orientation, and therefore cannot be understood as a limitation to the present disclosure.

In the description of this specification, the description with reference to the terms “one embodiment”, “another embodiment”, etc. means that a specific feature, structure, material, or characteristic described in conjunction with the embodiment is included in at least one embodiment of the present disclosure. In this specification, the schematic representations of the above terms do not necessarily refer to the same embodiment or example. Moreover, the described specific features, structures, materials or characteristics can be combined in any one or more embodiments or examples in a suitable manner. In addition, those skilled in the art can combine different embodiments or examples and features of different embodiments or examples described in this specification without contradicting each other. In addition, it should be noted that in this specification, the terms “first”, “second”, etc. are only used for descriptive purposes, and cannot be understood as indicating or implying relative importance or implicitly indicating the number of indicated technical features.

As those skilled in the art will understand, although the various steps of the method in the present disclosure are described in a specific order in the accompanying drawings, this does not require or imply that these steps must be performed in the specific order, unless the context clearly indicates otherwise. Additionally or alternatively, multiple steps can be combined into one step for execution, and/or one step can be decomposed into multiple steps for execution. In addition, other method steps can be inserted between the steps. The inserted step may represent an improvement of the method such as described herein, or may be unrelated to the method. In addition, a given step may not be fully completed before the next step starts.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, and the patent protection scope of the present disclosure should be defined by the claims. Other variations to the disclosed embodiments can be understood and effected by those skilled in the art in practicing the claimed invention, from a study of the drawings, the disclosure, and the appended claims. In the claims, the word “comprising” does not exclude other elements or steps, and the terms “a”, “an” and “the” in the singular form do not exclude a plurality. The mere fact that certain measures are recited in mutually different dependent claims does not indicate that a combination of these measures cannot be used to advantage. Any reference signs in the claims should not be construed as limiting the scope.

1. A first substrate for a microfluidic device, comprising:
a first area comprising at least one first module for generating droplets, the first module comprising a first electrode pair and a second electrode pair,
wherein the first electrode pair and the second electrode pair are arranged in a crisscross pattern.

2. The first substrate of claim 1, wherein the first electrode pair comprises a first electrode and a second electrode, and the second electrode pair comprises a third electrode and a fourth electrode.

3. The first substrate of claim 2, wherein a width of the first electrode gradually decreases in a first direction, and a width of the second electrode gradually increases in the first direction.

4. The first substrate of claim 3, wherein a width of the third electrode gradually decreases in a second direction, a width of the fourth electrode gradually increases in the second direction, and the second direction is perpendicular to the first direction.

5. The first substrate of claim 2, wherein outer edges of the first electrode, the second electrode, the third electrode, and the fourth electrode form a quadrilateral.

6. The first substrate of claim 5, wherein the outer edges of the first electrode, the second electrode, the third electrode, and the fourth electrode form a square.

7. The first substrate of claim 6, wherein facing ones of the outer edges of the first electrode and the second electrode have a radius of curvature greater than a quarter of a side length of the square.

8. The first substrate of claim 7, wherein shapes of the first electrode and the second electrode are semicircles.

9. The first substrate of claim 6, wherein facing ones of the outer edges of the first electrode and the second electrode have a radius of curvature less than a quarter of a side length of the square.

10. The first substrate of claim 9, wherein shapes of the first electrode and the second electrode are isosceles triangles.

11. The first substrate of claim 2, wherein a pattern composed of the first electrode, the second electrode, the third electrode, and the fourth electrode is a centrally symmetric pattern.

12. The first substrate of claim 2, wherein shapes of the third electrode and the fourth electrode match the shapes of the first electrode and the second electrode.

13. The first substrate of claim 2,
wherein the first module further comprises a fifth electrode, a sixth electrode, a seventh electrode arranged in sequence along a second direction upstream of the first electrode, the second electrode, the third electrode, and the fourth electrode, and an eighth electrode downstream of the first electrode, the second electrode, the third electrode, and the fourth electrode, and
wherein the sixth electrode comprises a recess, and at least a part of the seventh electrode is in the recess of the sixth electrode.

14. The first substrate of claim 13, wherein at least half of a width of the seventh electrode in the second direction is in the recess of the sixth electrode.

15. The first substrate of claim 13, wherein the fifth electrode and the sixth electrode are arranged in an interdigital electrode arrangement.

16. The first substrate of claim 13, wherein gaps exist between every two adjacent electrodes of the first to eighth electrodes, and the gaps have a constant width.

17. The first substrate of claim 1, wherein the first area is selected from at least one of a sample and reagent storage area and a detergent storage area.

18. The first substrate of claim 1, wherein the first substrate further comprises a second area and a third area, the third area comprises a second module, a third module, and a fourth module, and the second module is connected to the second area through a first electrode path, the third module and the fourth module are connected to the second area through a second electrode path.

19. The first substrate of claim 18, wherein the second area comprises a purification area, the third area comprises a sample output area, the second module comprises a waste liquid module, the third module comprises a quality control module, and the fourth module comprises a product module.

20. The first substrate of claim 18, further comprising:
a first base substrate;
a metal wiring layer on the first base substrate;
an insulating layer on a side of the metal wiring layer away from the first base substrate;
an electrode layer on a side of the insulating layer away from the first base substrate;
a dielectric layer on a side of the electrode layer away from the first base substrate; and
a hydrophobic layer on a side of the dielectric layer away from the first base substrate.

21. The first substrate of claim 20, wherein the first module, the second module, the third module, and the fourth module are in the electrode layer, and each electrode of the first module, the second module, the third module and the fourth module is connected to the metal wiring layer through a via penetrating the insulating layer.

22. The first substrate of claim 20, wherein the electrode layer is an ITO layer.

23. A microfluidic device, comprising a first substrate according to claim 2, a second substrate assembled with the first substrate, and a slit between the first substrate and the second substrate,
wherein the second substrate comprises:
a second base substrate;
a conductive layer on the second base substrate; and
a hydrophobic layer on a side of the conductive layer away from the second base substrate.

24. A driving method for the microfluidic device of claim 23, comprising:
energizing a fifth electrode, a sixth electrode, and a seventh electrode;
energizing the first electrode, the second electrode, the third electrode, and the fourth electrode, while de-energizing the fifth electrode, the sixth electrode, and the seventh electrode;
energizing an eighth electrode;
de-energizing the first electrode and the second electrode, while energizing the fifth electrode, the sixth electrode, and the seventh electrode;
de-energizing the third electrode and the fourth electrode; and
de-energizing the seventh electrode.
